(19) United States
(12) Patent Application Publication
(10) Pub. No.: US 2021/0037787 A1
(43) Pub. Date: Feb. 11, 2021

(54) PORTABLE PET WASTE STORAGE DEVICE

(71) Applicant: Sally Ann Beck, Canfield, OH (US)

(72) Inventor: Sally Ann Beck, Canfield, OH (US)

(21) Appl. No.: 16/986,554

(22) Filed: Aug. 6, 2020

Related U.S. Application Data
(60) Provisional application No. 62/883,464, filed on Aug. 6, 2019.

(51) Int. Cl. A01K 23/00; A01K 27/00

(52) U.S. Cl. CPC A01K 23/00; A01K 27/008; A01K 27/001

(57) ABSTRACT

A portable pet waste storage device has a body having a cavity formed by a front wall, a back wall, two sidewalls and a bottom wall. A flap is attached to one of the front and back walls. The flap rotates between open and closed positions on the device. An attachment member attaches the device to a pet garment such as a leash or collar.

### CLAIM OF PRIORITY

This application claims priority from Provisional Application Ser. No. 62/883,464 filed on Aug. 6, 2019, the entirety of which is hereby incorporated by reference.

The present disclosure relates to a device and method for sanitary handling of biological waste or excrement from pets and other animals.

### BACKGROUND OF THE DISCLOSURE

Pet owners, caregivers, and other pet handlers are often faced with the problem of how-to best clean-up and dispose of a pet's excrement in a sanitary manner. This is especially so in public settings, where common courtesy and public health dictate that a pet's droppings are not left behind.

A common tactic used for picking-up after pets is to have a supply of plastic bags on hand which can be used to retrieve a pet's excrement from the ground. However, the pet handler then often must hold the bagged excrement for long periods of time until a receptacle is found for permanent disposal. Having to hold the bagged excrement results in potentially unsanitary conditions for the pet handler and others coming into contact therewith. Moreover, having to hold the bagged excrement restricts the pet handler's use of that hand when it is safer for the pet's handler, the pet itself, and other members of the public that the pet's handler have both hands available.

Thus, there is a need to provide a convenient and sanitary option for temporarily storing a pet's bagged excrement until a permanent disposal option becomes available. A device and method of using the device which provides this option is the objective of the present disclosure.

### SUMMARY OF THE DISCLOSURE

The present disclosure relates to a portable pet waste storage device which is specially adapted to be carried by the pet itself. The device generally includes a pouch or container body configured to temporarily store a pet or other animal's bagged excrement until it a permanent disposal option becomes available.

The container body of the device is made from a lightweight, insulative material. The material itself can have insulative properties or an insulating material can be included in the construction of the container body. Moreover, one or more additives can be included in or on the construction material to provide additional desirable characteristics, such as odor reduction.

In accordance with one embodiment of the disclosure, a portable pet waste storage device has a body having a cavity formed by a front wall, a back wall, sidewalls and a bottom wall; a flap attached to one of the front and back walls wherein the flap rotates between open and closed positions on the device; and an attachment member which attaches the device to a pet garment such as a leash or collar.

In accordance with another embodiment of the disclosure, a method of attaching a pet waste storage device to a pet garment includes: mounting the container body to a corresponding pet garment; picking up pet waste with a bag; opening the lid; and placing the bagged excrement into an interior region of the container. The owner or caregiver then closes the lid and latches it in place with a closing mechanism. The owner or caregiver can then continue the walk with his or her pet without having to hold the bagged excrement. Once a permanent waste disposal option is available, the owner or caregiver opens the lid of the container body, removes the bagged excrement from the interior region , and throws the bagged excrement away.

Still other embodiments of the disclosure will be apparent upon a reading and understanding of the following detailed disclosure.

### BRIEF DESCRIPTION OF THE DRAWINGS

Embodiments of the present disclosure are described with reference to the following figures:

FIG. 1 is a right-side perspective view of an exemplary embodiment of a portable pet waste storage device in an open configuration according to the present disclosure;

FIG. 2 a left-side perspective view of the portable pet waste storage device of FIG. 1, the device being shown in a closed configuration according to the present disclosure;

FIG. 3 is a close-up cross-sectional view of an exemplary embodiment of a multilayer material construction used to form the portable pet waste storage device shown in FIG. 1;

FIG. 4 is a back-side perspective view of the portable pet waste storage device of FIG. 1; and,

FIG. 5 illustrates the portable pet waste storage device of FIG. 1 being carried by a pet dog.

### DETAILED DESCRIPTION OF THE DISCLOSURE

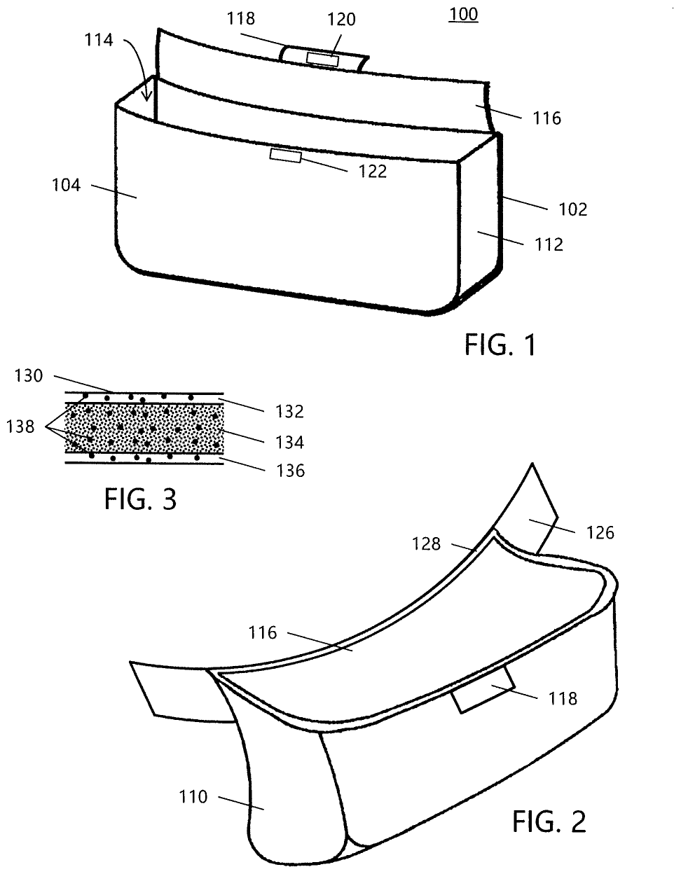

Referring now to FIGS. 1-5, a portable pet waste storage device 100 adapted to be carried by a pet is shown in accordance with an exemplary embodiment of the present disclosure. The device 100 includes a pouch or container body 102 for temporary storage of a pet or other animal's bagged excrement until it can be permanently disposed of in a trash can or dumpster. The container body 102 generally includes a front wall 104, a back wall 106, a bottom wall 108, a left sidewall 110, and a right sidewall 112. These walls collectively define an interior region or cavity 114 suitable for temporary storage of pet excrement typically retrieved by the pet's owner, caregiver, or other handler with a bag or other item commonly used to pick-up after pets.

The container 102 further includes a flap or lid 116 which is generally attached to the top portion of the back wall 106. The lid 116 can fold or rotate toward and away from both the front and back wall 104, 106. In an open configuration of the container 102, the lid is folded or rotated away from the front wall and toward the back wall. The open configuration is best shown in FIG. 1, where the interior region 114 is easily accessible for placement or removal of bagged excrement.

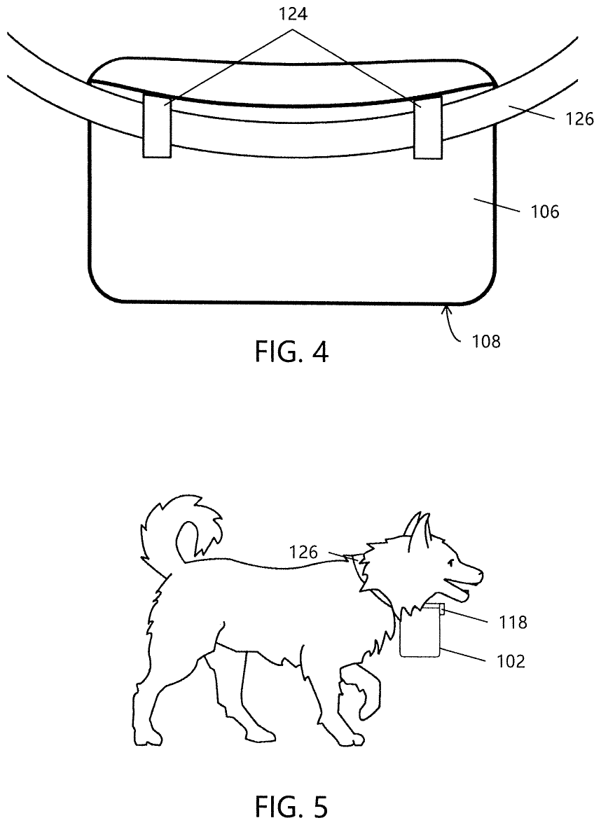

In a closed configuration of the container 102, the lid is folded or rotated toward the front wall and away from the back wall. The closed configuration is best shown in FIGS. 2 and 4, where the lid 116 securely covers the interior region 114 to prevent any bagged excrement that may be stored therein from falling out.

The closed configuration of the container 102 is generally maintained by one or more closing mechanisms. In some embodiments, the closing mechanism includes a latch 118 disposed on the lid 116. In such embodiments, a first securement feature 120 disposed on the latch 118 is configured to easily engage and disengage with a corresponding second securement feature 122 disposed on the front wall 104. When the first and second securement features 120, 122 are engaged, the latch 118 securely fastens the lid 116 with the front wall 104 to maintain the closed configuration.

In some particular embodiments, the first and second securement features 120, 122 are individual parts of a snap fastener known in the art. In other particular embodiments, the first and second securement features 120, 122 are hook and loop fasteners, such as Velcro®. In some other embodiments, the first and second securement features 120, 122 are magnetic fasteners known in the art.

While the specific closing mechanism shown in corresponding FIGS. 1-5 includes the latch and securement features described above, it should be understood that other closing mechanism arrangements could also be used without departing from the scope of the present disclosure. For example, a zipper could be used to secure the lid to the front wall and left and right sidewalls of the container.

The portable pet waste storage device 100 of the present disclosure further includes one or more attachment features 124 adapted to mount the container body 102 to a corresponding pet garment 126 such as a leash or collar. In this regard, the portable pet waste container and any bagged excrement stored therein are carried by the pet (such as the dog illustrated in FIG. 5) instead of the pet owner, caregiver, or other handler, thereby permitting the pet handler to use their hands for other tasks (e.g., holding a leash). As used herein, a pet garment includes any item or accessory which pet owners or caregivers commonly place on a pet for a particular purpose, such as the collar 126 illustrated in FIGS. 2, 4, and 5. Other exemplary pet garments may include but are not limited to walking harnesses, vests, jackets, muzzles, calming shirts, etc., and the like.

As best seen in FIG. 4, the one or more attachment features 124 are generally disposed on the back wall 106 of the container body. However, the specific location of the one or more attachment features of the present disclosure non-limiting. The one or more attachment features can include webbed straps 124 attached to the back wall 106 of the container to form slots or loops through which the corresponding pet garment 126 can be received. For example, when the pet garment 126 is a collar as illustrated in FIGS. 2, 4, and 5, one end of the collar is threaded through the loops formed by webbed straps 124 before being attached to the other end of the collar. Other exemplary attachment features may include but are not limited to swivel snap bolts, fixed loop snaps, split attachment rings, etc., and the like.

While the specific dimensions of the portable pet waste storage device 100 described herein are non-limiting, the size of the container body 102 generally corresponds to pet size and dimensions of the associated pet garment 126. For example, dog collars are commonly provided in sizes which correspond to the circumference of the dog's neck, including XX-small for neck sizes of about 6-8″, X-small for neck sizes of about 8-12″, small for neck sizes of about 10-14″, medium for neck sizes of about 14-20″, large for neck sizes of about 16-26″, and X-large for neck sizes of about 24-30″. In this regard, container body 102 can optionally be sized to have a total length of no more than about 1-2″ longer than a collar diameter of the aforementioned neck circumference sizes. As such, the overall length of the device may be about 3-4.5″ for pets with XX-small neck sizes, about 3.5-6″ for pets with X-small neck sizes, about 4-6.5″ for pets with small neck sizes, about 5.5 - 8″ for pets with medium neck sizes, about 6-10″ for pets with large neck sizes, and about 9-11.5″ for pets with X-large neck sizes. Such sizes optimize the pet's comfort while carrying the device without sacrificing usability of the device itself.

In some embodiments, the container body 102 can include optional piping or ribbing, such as piping or ribbing 128 illustrated in FIG. 2, which provides additional structure, shape retention, and durability without greatly affecting weight of the device. While the optional piping or ribbing 128 is shown in FIG. 2 as being disposed only around the perimeter of the lid 116, it should be understood that piping or ribbing could also be included in other locations without departing from the scope of the present disclosure. For example, piping or ribbing could be included along the various edges formed by the intersection of walls 104,106,108,110, and 112.

The portable pet waste storage device 100 of the present disclosure is generally made of a light-weight material to help prevent from excessive strain being placed on the pet or animal carrying the device. Exemplary light-weight materials used to make the exemplary device include but are not limited to fabrics such as nylon, vinyl, polyester, canvas, mesh, etc., rubbers, plastics, polymers, and combinations thereof.

The portable pet waste storage device 100 of the present disclosure can also be generally made of or include an insulating material that helps prevent degradation and reduce odor escaping the container body. Exemplary insulating materials include but are not limited to foam, fiberglass, mineral wool, cellulose, polyurethane, polystyrene, polyethylene, polyester, polypropylene, etc., and the like.

In some embodiments, the container body 102 of the pet waste storage device 100 is constructed from one or more layers of the exemplary light-weight material described above. In such embodiments, the one or more layers of light-weight material can be coated on one or both sides with a hydrophobic or water-resistant material to help prevent undesirable moisture absorption.

In some particular embodiments, the container body 102 of the pet waste storage device 100 has a multilayer construction, such as the multilayer arrangement 130 illustrated in FIG. 3. The multilayer arrangement 130 generally includes a first or inner layer 132, a second or outer layer 136, and an intermediate or middle layer 134 disposed between the inner and outer layers. In such embodiments, the inner layer 132 is typically comprised of an impermeable, hydrophobic, or water-resistant material such as plastic, aluminum, vinyl, foil, rubber, plastic, etc., and the like. The water-resistant inner layer 132 is useful for preventing absorption of moisture from the bagged excrement by the middle or outer layers 134, 136. The middle layer 134 typically comprises an insulating foam or other insulating material such as polyurethane, polyethylene plastic, polyester fibers, polystyrene, etc., and the like. The insulating middle layer 134 is useful for preventing external environmental factors (e.g., temperature) from further degrading the bagged excrement and increasing malodor. The outer layer 136 is typically comprised of a tough material resistant to staining or tearing. Furthermore, the outer layer 136 can also be impermeable, hydrophobic, or water-resistant to help prevent absorption of moisture from the external environment by the inner and middle layers 132, 134 and the bagged excrement.

In other embodiments, the multilayer arrangement 130 of the container body 102 may include one or more additives 138 impregnated within or disposed on inner layer 132, middle layer 134, and/or outer layer 136. For example, the one or more additives 138 may comprise a disinfecting or sanitizing material to help prevent the spread of germs and bacteria from the bagged excrement. As another example, the one or more additives 138 may be comprised of a deodorizing material which helps reduce the malodor of the bagged excrement. In yet another example, the one or more additives 138 may also comprise a desiccant material for absorbing moisture within the container body. While the one or more additives 138 are illustrated as being included with the multilayer material construction shown in FIG. 3, the one or more additives could also be impregnated within or disposed on any other material construction without departing from the scope of the present disclosure.

The portable pet waste storage device 100 of the present disclosure is generally employed when a pet owner, caregiver, or other handler walks his or her pet in a location where permanent waste disposal options are not readily available. The device is implemented by first mounting the container body 102 to a corresponding pet garment 126 as described above. If the pet expels excrement during the walk, the owner or caregiver picks up the waste with a bag, opens the lid 116, and places the bagged excrement in the interior region 114. The owner or caregiver then closes the lid and latches it in place with the closing mechanism described above. The owner or caregiver can then continue the walk with his or her pet without having to hold the bagged excrement. Once a permanent waste disposal option is available, the owner or caregiver opens the lid 116 of the container body 102, removes the bagged excrement from the interior region 114, and throws the bagged excrement away.

In some embodiments, the presently disclosed portable pet waste storage device 100 can optionally be included as part of a kit (not shown). The kit may further include, for example, an associated pet garment such as the collar 126 described above and a supply of plastic bags for retrieving and bagging a pet's excrement.

Moreover, although the portable pet waste storage device may be described and shown herein in the context of canine excrement, it should be apparent that the device may be used for containing the waste of any other domestic animal or pet, including but not limited to felines, ferrets, farm animals, rabbits, etc., and the like.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A portable pet waste storage device comprising:
a body having a cavity formed by a front wall, a back wall, first and second sidewalls and a bottom wall;
a flap attached to one of said front and back walls wherein said flap rotates between open and closed positions on said device; and
an attachment member for attaching said device to an associated pet garment.

2. The portable pet waste storage device wherein said attachment member comprises webbed straps attached to said back wall of said device.

3. The portable pet waste storage device of claim 2, wherein said straps comprise slots for receiving said associated pet garment.

4. The portable pet waste storage device of claim 1, wherein said body further comprises ribbing formed on said flap.

5. The portable pet waste storage device of claim 1, wherein said body comprises a first inner layer, a second outer layer and a third middle layer disposed between said first and second layers.

6. The portable pet waste storage device of claim 5, wherein said middle layer comprises an insulating layer such as foam.

7. The portable pet waste storage device of claim 5, wherein said inner layer comprises water resistant material.

8. The portable pet waste storage device of claim 5, wherein said outer layer comprises water resistant and tear resistant material.

9. The portable pet waste storage device of claim 5, wherein said body further comprises additives disposed on at least one of said outer layer, middle layer and inner layer.

10. The portable pet waste storage device of claim 9, wherein said additives comprise a disinfecting material.

11. A method of using a pet waste storage device with a pet garment comprising:
attaching a body of said device to said associated pet garment with an attachment member;
picking up pet waste with a bag;
opening a lid of said device;
placing bagged waste into an interior region of said device body;
closing the lid and latching it in place with a closing mechanism;
opening the lid of said body;
removing the bagged waste from the interior region; and
throwing the bagged waste away.

12. The method of claim 11, wherein said attachment member comprises webbed straps attached to a back wall of said device.

13. The method of claim 12, wherein said straps comprise slots for receiving said associated pet garment.

14. The method of claim 11, wherein said body further comprises ribbing formed on said lid.

15. The method of claim 11, wherein said body comprises a first inner layer, a second outer layer and a third middle layer disposed between said first and second layers.

16. The method of claim 15, wherein said middle layer comprises an insulating layer such as foam.

17. The method of claim 16, wherein said inner layer comprises water resistant material.

18. The method of claim 17, wherein said outer layer comprises water resistant and tear resistant material.

19. The method claim 15, wherein additives are disposed on at least one of said outer layer, middle layer and inner layer of said body.

20. The method of claim 19, wherein said additives comprise a disinfecting material.
